(19) United States
(12) Patent Application Publication
(10) Pub. No.: US 2010/0019898 A1
(43) Pub. Date: Jan. 28, 2010

(54) PRE-VALIDATED WIRELESS SENSORS FOR PHARMACEUTICAL OR OTHER APPLICATIONS AND RELATED SYSTEM AND METHOD

(75) Inventor: Anthony F. Porrazza, Bensalem, PA (US)

Correspondence Address: Anthony Miologos;Honeywell International Inc, 101 Columbia Road, PO BOX 2245, Morristown, NJ, 07962, US

(73) Assignee: Honeywell International Inc., Morristown, NJ (US)

(21) Appl. No.: 12/177,634

(22) Filed: Jul. 22, 2008

(51) Int. Cl. G08B 21/00; H04Q 7/00

(52) U.S. Cl. 340/540; 340/539.1

(57) ABSTRACT

A method includes installing a wireless sensor in a specified operational environment, wherein the wireless sensor is pre-validated for use in the specified operational environment. The method also includes operating the wireless sensor to obtain information. The method further includes wirelessly transmitting data, where the data includes the obtained information and/or information based on the obtained information. The specified operational environment could represent a pharmaceutical manufacturing environment. The method could also include receiving one or more network settings at the wireless sensor, where the data is wirelessly transmitted using the one or more network settings. The receipt of the one or more network settings may not alter the pre-validation of the wireless sensor to operate in the specified operational environment.

### TECHNICAL FIELD

This disclosure relates generally to wireless sensor systems and more specifically to pre-validated wireless sensors for pharmaceutical or other applications and related system and method.

### BACKGROUND

Industrial processes, such as pharmaceutical processes, typically require monitoring, which often involves the use of multiple sensors distributed throughout the processes. Among other things, this monitoring helps to ensure the quality of the processes. The reliability of the sensors is important. Not only do the sensors provide a passive mechanism for monitoring the status of the industrial processes, data from the sensors often forms the basis for active decision making during operation of the industrial processes.

### SUMMARY

This disclosure provides a pre-validated wireless sensor for pharmaceutical or other applications and related system and method.

In a first embodiment, a method includes installing a wireless sensor in a specified operational environment, wherein the wireless sensor is pre-validated for use in the specified operational environment. The method also includes operating the wireless sensor to obtain information. The method further includes wirelessly transmitting data, where the data includes the obtained information and/or information based on the obtained information.

In a second embodiment, a wireless sensor includes at least one sensing element configured to sense one or more environmental conditions. The wireless sensor also includes a data processing system configured to process measurement data received from the at least one sensing element. The wireless sensor further includes an antenna configured to wirelessly transmit data from the data processing system, where the data includes the measurement data and/or information based on the measurement data. In addition, the wireless sensor includes a power source configured to power at least the data processing system. The wireless sensor is pre-validated for use in a specified operational environment.

In a third embodiment, a system includes a plurality of wireless sensors. The wireless sensors are pre-validated for use in a specified operational environment.

In a fourth embodiment, a method includes designing a wireless sensor for sensing one or more environmental conditions. The method also includes pre-validating the wireless sensor for use in a specified operational environment prior to installation of the wireless sensor.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example wireless sensor according to this disclosure;

FIG. 2 illustrates an example data processing system according to this disclosure; and

FIGS. 3 and 4 illustrate example deployments of wireless sensors in an industrial facility according to this disclosure.

### DETAILED DESCRIPTION

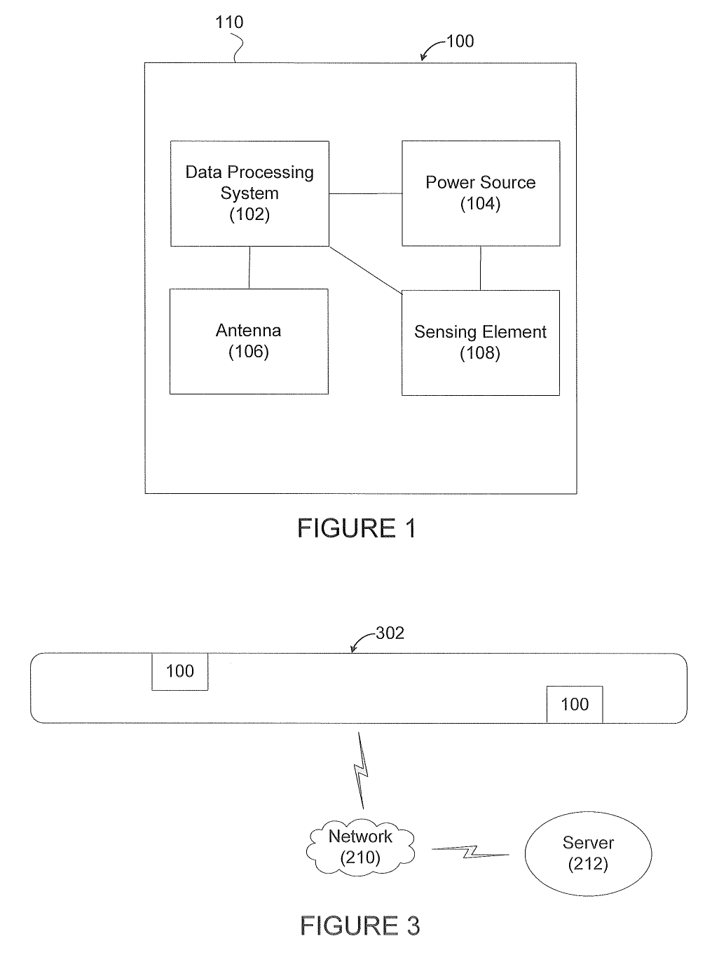

FIGS. 1 through 4, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example wireless sensor 100 according to this disclosure. The embodiment of the wireless sensor 100 shown in FIG. 1 is for illustration only. Other embodiments of the wireless sensor 100 could be used without departing from the scope of this disclosure.

As shown in FIG. 1, the wireless sensor 100 includes a data processing system 102, a power source 104, an antenna 106, and at least one sensing element 108. An outer casing 110 contains, encases, or otherwise supports these elements of the wireless sensor 100. In this example, the data processing system 102 can process data captured by the sensing element 108 and transmit the data wirelessly via the antenna 106. The power source 104 provides operating power to the data processing system 102 and the sensing element 108.

The power source 104 in this example represents any suitable structure for providing power to components of the wireless sensor 100. Example power sources 104 could include batteries, fuel cells, or solar cells. It is understood that components of the power source 104 or some types of power sources 104 may reside outside of the outer casing 110. In such a case, the outer casing 110 may be designed to facilitate these types of power sources, such as by providing connections from an internal power source 104 to an exposed surface on the outside of outer casing 110.

The antenna 106 represents any suitable structure for transmitting or receiving a wireless signal, such as a radio frequency (RF) antenna. It is understood that the antenna 106 may be used to send or receive information. It is also understood that the antenna 106 could be coupled to the power source 104 to create a powered antenna.

The sensing element 108 is configured to collect any suitable information relating to the environment surrounding the outer casing 110 or the sensing element 108. The sensing element 108 could, for example, include a pressure sensor, temperature sensor, current sensor, pH sensor, or any other or additional kind of sensor. Again, it is understood that some components of the sensing element 108 or some types of sensing elements 108 may reside outside of the outer casing 110 (such as a temperature probe). In such a case, the outer casing 110 may be designed to allow the sensing element 108 to obtain a reading from the environment outside of the outer casing 110. Also, the information obtained by sensing element 108 can be transferred to the data processing system 102, which could then process the information or forward the information to the antenna 106 for transmission. While a single sensing element 108 is illustrated in FIG. 1, it is understood that multiple sensors may be integrated into the sensing element 108.

The outer casing 110 represents any type of structure for containing, enclosing, or otherwise supporting the data processing system 102, the power source 104, the antenna 106, and the sensing element 108. The outer casing 110 may be formed of any suitable material(s), such as metal or plastic. There may be one or more openings in the outer casing 110, such as openings associated with the power source 104, antenna 106, or sensing element 108.

Many companies, industries, and other entities have laws, rules, regulations, or other requirements that govern the operation of processing facilities. For example, pharmaceutical manufacturers are often subject to legal, safety, or other requirements that govern their manufacturing or processing facilities. In these types of facilities, it is often not possible to simply install any wireless sensors or other devices in those processing facilities.

In accordance with this disclosure, the wireless sensor 102 can be configured and calibrated prior to deployment in an industrial process or other environment. The configuration and calibration removes the need for on-site configuration and manual calibration of the wireless sensor 100. The configuration may include configuring the data processing system 102 to report sensed information securely to one or more servers or other destinations. In this way, multiple wireless sensors 100 may be rapidly deployed in an industrial process or other environment.

Moreover, the wireless sensors 100 may be pre-validated to work in specific types of environments. For example, after installation of the sensing element 108 into the outer casing 110, the sensing element 108 could be tested in order to validate the sensor. The term “validate” refers to the process by which a component is tested in a known environment to confirm the proper operation of the component. This validation is performed prior to the wireless sensor 100 being deployed, so it may be referred to as “pre-validation.”

Part of pre-validating the wireless sensor 100 could include calibrating the sensing element 108 to a specific tolerance depending on what the wireless sensor 100 is designed to detect. For instance, if the wireless sensor 100 is designed to detect temperature, the sensing element 108 can be calibrated to detect a specific range of temperatures with a given tolerance. Another part of pre-validating the wireless sensor 100 could include performing diagnostics on the sensing element 108 to ensure proper operation. Types of problems with the sensing element 108 that can be detected during diagnostics may include bias, drift, and complete or partial failure.

As a specific example of pre-validation, one of the problems in pharmaceutical applications is the need for highly accurate sensors that can readily be deployed into a variety of environments. For instance, some sensors may be placed on the outside of large reaction vessels, while other sensors may be placed inside of reaction vessels. When a wireless sensor 100 is placed into the reaction vessel, the wireless sensor 100 may be exposed to dangerous conditions, including extremes in pH, temperature, pressure, and heat. The outer casing 110 protects the other components of the wireless sensor 100 and prevents damage to those components during use. The outer casing 110 of the wireless sensor 100 could therefore be pre-validated to ensure that the outer casing 110 satisfies any requirements related to these types of conditions. Moreover, since the wireless sensor 100 is pre-validated and configured, it can be rapidly deployed into any environment without the need for modification on site.

After the wireless sensor 100 is pre-validated (such as during installation), the data processing system 102 can be programmed to communicate with a specific destination, such as a specific server. The communications may be secured in one or multiple ways. For example, the actual sensor data may be signed by the data processing system 102, such as by using pretty good privacy (PGP) digital signatures. The communications may also be encrypted using any encrypted wireless technique, such as Wi-Fi protected access (WPA or WPA2) or Wired Equivalent Privacy (WEP). It is understood that by using a secure connection between the data processing system 102 and the destination, accurate results can be reported to the specific destination. Signing the data may be directly primarily at ensuring the authenticity of the data, and encrypting the data may be directly primarily at ensuring the privacy of the data.

In this way, the wireless sensor 100 can be pre-validated for use in a specific environment or type of environment. Installation of the wireless sensor 100 is therefore simplified. Moreover, the pre-validation may allow the wireless sensor 100 to be placed in environments where wireless sensors are often difficult to use, such as in pharmaceutical environments.

Although FIG. 1 illustrates one example of a wireless sensor 100, various changes may be made to FIG. 1. For example, the functional division shown in FIG. 1 is for illustration only. Various components could be combined, subdivided, or omitted and additional components could be added according to particular needs.

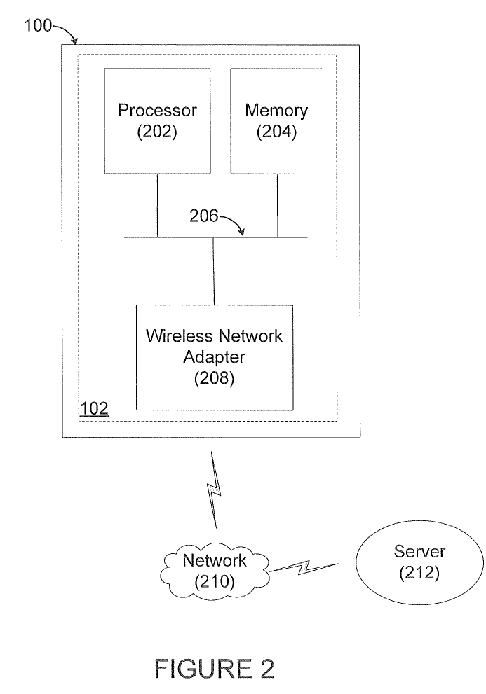

FIG. 2 illustrates an example data processing system 102 according to this disclosure. The embodiment of the data processing system 102 shown in FIG. 2 is for illustration only. Other embodiments of the data processing system 102 could be used without departing from the scope of this disclosure.

In this example, the data processing system 102 includes a processor 202 and a memory 204 coupled to a local system bus 206. The processor 202 represents any suitable processing device, such as a microprocessor, microcontroller, field programmable gate array, or digital signal processor. The memory 204 represents any suitable storage and retrieval device or devices, such as one or more volatile or non-volatile memories. The local system bus 206 represents any suitable bus or other communication link, such as a peripheral component interconnect (PCI) architecture bus.

Also connected to the local system bus 206 in this example is a wireless network adapter 208. The wireless network adapter 208 facilitates wireless communications with the wireless sensor 100. For example, the wireless network adapter 208 could facilitate the transmission of sensor data to an external destination wirelessly (via the antenna 106). The wireless network adapter 208 includes any suitable structure facilitating wireless communications. The wireless network adapter 208 could, for example, represent an RF or other transceiver. Also, the wireless network adapter 208 could communicate over any suitable wireless network using any suitable protocol, such as by using an 802.11-based protocol to communicate over a wireless local area network or wide area network.

In this example, the wireless network adapter 208 can communicate over a network 210, which could represent any public or private network or combination of networks (including the Internet). The data processing system 102 can communicate with a server system 212 over the network 210. The server system 212 could represent any suitable computing or processing system and could actually be similar or identical in structure to the data processing system 102. The wireless network adapter 208 may be capable of providing secured wireless connections using an encryption scheme.

As described above, the data processing system 102 can be incorporated into the wireless sensor 100. In the wireless sensor 100, the processor 202 can process sensor data generated by the sensing element 108. The processing could, for example, involve comparing the sensor measurements to thresholds and identifying problems. The processing could also involve preparing the sensor measurements, any alarms, or other data associated with the sensor measurements for wireless transmission. The sensor measurements or any other data and instructions could be stored in the memory 204, and the data to be transmitted can be sent across the local system bus 206 to the wireless network adapter 208 for transmission. In some embodiments, the processor 202 could also receive data from the wireless network adapter 208, such as commands to perform particular functions, and use the data.

Although FIG. 2 illustrates one example of a data processing system 102, various changes may be made to FIG. 2. For example, the functional division shown in FIG. 2 is for illustration only. Various components could be combined, subdivided, or omitted and additional components could be added according to particular needs. Also, while a server system 212 is shown as the destination for data from the data processing system 102, data from the data processing system 102 could be provided to any other or additional destinations.

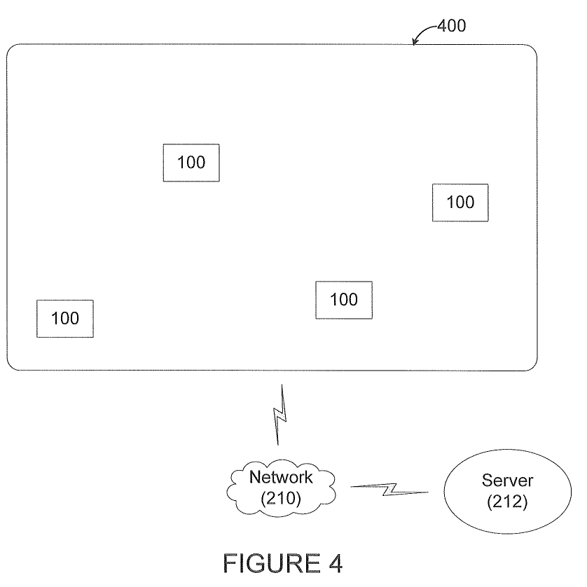

FIGS. 3 and 4 illustrate example deployments of wireless sensors 100 in an industrial facility according to this disclosure. The example deployments shown in FIGS. 3 and 4 are for illustration only. The wireless sensors 100 could be used in any other suitable manner without departing from the scope of this disclosure.

As shown in FIG. 3, multiple wireless sensors 100 are deployed in an industrial pipe 302. The wireless sensors 100 detect at least one environmental condition within the industrial pipe 302, such as temperature, pressure, composition, or flow rate. Readings related to the conditions within the industrial pipe 302 are taken, and the readings can be processed. The readings or data associated with those readings can then be transmitted through the network 210 to the server 212.

Additional wireless sensors 100 may be added to the industrial pipe 302. In order to add the wireless sensors 100 to the industrial pipe 302, the wireless sensors 100 can be configured beforehand to communicate with the server 212. Once the additional wireless sensors 100 are configured, they can be placed at any point within the industrial pipe 302.

To configure new wireless sensors 100 to communicate with the server 212, the new wireless sensors 100 can be programmed to enter a “discover” mode. During this time, the server 212 may discover the new wireless sensors 100 and configure the network settings of those wireless sensors 100. The network configurations of the new wireless sensors 100 (used to communicate with the server 212) typically do not alter the digital signatures of the wireless sensors 100. Therefore, the integrity of the wireless sensors 100 (and therefore the validity of the pre-validation) may be maintained even if their network configurations are altered by the server 212.

As shown in FIG. 4, multiple wireless sensors 100 are used within a large oven 402. Again, the wireless sensors 100 in the oven 402 communicate with the server 212 through the network 210. Also, additional wireless sensors 100 can be added to the oven 402, and a discovery mode can be used to discover and configure the wireless sensors 100.

It is understood that the wireless sensors 100 may be used in any kind of industrial structure or environment, including boilers, ovens, pipes, heat exchangers, distillers, or other components. It is also understood that multiple wireless sensors 100 may be sold embedded into an industrial structure in order to allow for rapid deployment. One example is a plastic vessel that may be used for a biological reaction. The plastic vessel may be sold with multiple wireless sensors 100 embedded into or under the plastic. These sensors 100 may be used to transmit data back to a preconfigured server.

Although FIGS. 3 and 4 illustrate examples of deployments of wireless sensors 100 in an industrial facility, various changes may be made to FIGS. 3 and 4. For example, any number of wireless sensors 100 could be used with any number of industrial equipment pieces.

It may be advantageous to set forth definitions of certain words and phrases used throughout this patent document. The terms “include” and “comprise,” as well as derivatives thereof, mean inclusion without limitation. The term “or” is inclusive, meaning and/or.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
installing a wireless sensor in a specified operational environment, the wireless sensor pre-validated for use in the specified operational environment;
operating the wireless sensor to obtain information; and
wirelessly transmitting data, the data comprising at least one of: the obtained information and information based on the obtained information.

2. The method of claim 1, wherein wirelessly transmitting the data comprises:
adding identification data to the obtained information;
digitally signing the identification data and the obtained information;
encrypting the digitally signed information; and
transmitting the encrypted information.

3. The method of claim 1, wherein the wireless sensor comprises at least one of: a pH sensor, a temperature sensor, a current sensor, and a pressure sensor.

4. The method of claim 1, wherein installing the wireless sensor comprises installing the wireless sensor in one of: an industrial reaction vessel and an industrial pipe.

5. The method of claim 1, further comprising:
powering the wireless sensor with an internal power source.

6. The method of claim 1, wherein the specified operational environment comprises a pharmaceutical manufacturing environment.

7. The method of claim 1, further comprising:
receiving one or more network settings at the wireless sensor;
wherein wirelessly transmitting the data comprises wirelessly transmitting the data using the one or more network settings.

8. The method of claim 7, wherein receipt of the one or more network settings does not alter the pre-validation of the wireless sensor to operate in the specified operational environment.

9. A wireless sensor comprising:
at least one sensing element configured to sense one or more environmental conditions;
a data processing system configured to process measurement data received from the at least one sensing element;
an antenna configured to wirelessly transmit data from the data processing system, the data comprising at least one of: the measurement data and information based on the measurement data; and
a power source configured to power at least the data processing system;
wherein the wireless sensor is pre-validated for use in a specified operational environment.

10. The wireless sensor of claim 9, wherein the data processing system is configured to digitally sign and encrypt the measurement data prior to transmission of the measurement data.

11. The wireless sensor of claim 9, wherein the processing system comprises a processor, a memory, and a wireless network adapter.

12. The wireless sensor of claim 9, wherein the at least one sensing element comprises at least one of: a pH sensor, a temperature sensor, a current sensor, and a pressure sensor.

13. The wireless sensor of claim 9, wherein the specified operational environment comprises a pharmaceutical manufacturing environment.

14. A system comprising a plurality of wireless sensors, wherein the wireless sensors are pre-validated for use in a specified operational environment.

15. The system of claim 14, wherein at least one of the wireless sensors comprises:
at least one sensing element configured to sense one or more environmental conditions;
a data processing system configured to process measurement data received from the at least one sensing element;
an antenna configured to wirelessly transmit data from the data processing system, the data comprising at least one of: the measurement data and information based on the measurement data; and
a power source configured to power at least the data processing system.

16. The system of claim 14, further comprising:
a wireless network configured to transport the data transmitted by the wireless sensors.

17. The system of claim 14, further comprising:
a server configured to receive and process the data transmitted by the wireless sensors.

18. The system of claim 14, wherein the wireless sensors are configured to transmit the data using an IEEE 802.11 wireless standard.

19. The system of claim 14, wherein the wireless sensors comprise at least one of: a pH sensor, a temperature sensor, a current sensor, and a pressure sensor.

20. A method comprising:
designing a wireless sensor for sensing one or more environmental conditions; and
pre-validating the wireless sensor for use in a specified operational environment prior to installation of the wireless sensor.
